(19) United States
(12) Patent Application Publication
(10) Pub. No.: US 2010/0228906 A1
(43) Pub. Date: Sep. 9, 2010

(54) Managing Data in a Non-Volatile Memory System

(76) Inventors: Arunprasad Ramiya Mothilal, San Jose, CA (US); Sree Iyer, San Jose, CA (US)

Correspondence Address: CARR & FERRELL LLP, 2200 GENG ROAD, PALO ALTO, CA, 94303, US

(21) Appl. No.: 12/399,803

(22) Filed: Mar. 6, 2009

(51) Int. Cl. G06F 12/00

(52) U.S. Cl. 711/103; 707/E17.01; 711/E12.001

(57) ABSTRACT

Management of data in a non-volatile memory system is disclosed. A write command may be received that indicates a logical block address for writing data associated with the write command. The logical block address may be within a logical zone. The logical zone may be one of a plurality of logical zones within the non-volatile memory, wherein each of the plurality of logical zones comprises a different range of logical block addresses than the rest of the plurality of logical zones. The logical zone may further comprise a temporary storage block. The data associated with the write command may be written to the temporary storage block of the logical zone when a size of the data associated with the write command does not exceed a threshold. The data associated with the write command may be transferred from the temporary storage block to the logical block address in response to a trigger event.

### BACKGROUND OF THE INVENTION

1. Field of the Invention

The present invention relates generally to data management. More specifically, the present invention relates to managing data in a non-volatile memory system.

2. Related Art

Non-volatile memory such as NAND flash includes numerous blocks in which data can be stored. In order the overwrite data stored in a given block with new data, that entire block must be completely erased and rewritten to include the new data. Each block can be put through a limited number of erase-cycles before becoming unreliable or the data stored there being corrupted. With NAND flash, for instance, this limit may vary depending on the specific technology incorporated. Such erase-cycle limits may bring a premature end to a NAND flash-based device's life, especially if only a small portion of the blocks are repeatedly rewritten.

One approach for increasing longevity of flash-based devices is known as a software or firmware flash translation layer (FTL). FTL may perform processes to make a flash device appear as a storage device having small sectors. The FTL maintains a mapping between logical blocks and physical blocks to allow wear leveling. Generally speaking, wear leveling is an attempt to alleviate erase-cycle limitations by arranging data such that erasures and rewrites are distributed evenly across a particular device, thus reducing the likelihood that a single block will fail prematurely due to a high concentration of erase cycles.

NAND flash devices generally use conventional file systems like FAT16, FAT32, UFS, HFS, ext2, and NTFS. Many of these file systems were originally designed for magnetic disks and therefore rewrite many associated data structures repeatedly at the same locations. For example, operating systems like Microsoft Windows 2000, Microsoft Windows XP, and Windows Vista write a DOS boot record (DBR), a file allocation table (FAT), and root directory for every megabyte of user data.

Overhead is generally considered any combination of excess or indirect computation time, memory, bandwidth, or other resources that are required to be utilized or expended to enable a particular goal. The overhead associated with file system writes can be tremendous, especially for small file transfers, and may adversely affect overall performance. While FTL does address concentration of erase cycles, FTL does not reduce the total number of erasures. Thus, an approach for managing data is needed that addresses erase-cycle limitations as well as overhead.

### SUMMARY OF THE INVENTION

Embodiments of the present invention overcome or substantially alleviate prior problems associated with data management in non-volatile memory systems, particularly with respect to longevity and overhead.

Various embodiments of the present invention include methods for managing data in a non-volatile memory system wherein a write command is received that indicates a logical block address for writing data associated with the write command. The data associated with the write command may be file system data or user data. The logical block address may be within a logical zone that also comprises a temporary storage block. The logical zone may be one of a plurality of logical zones within non-volatile memory. Each of the plurality of logical zones may comprise a different range of logical block addresses than the rest of the plurality of logical zones. The data associated with the write command may be written to the temporary storage block of the logical zone when a size of the data associated with the write command does not exceed a threshold. In exemplary embodiments, the threshold may be a fixed value or a dynamic value.

These methods may optionally include updating a table associated with the temporary storage block to reflect the writing of the data associated with the write command to the temporary storage block. An outdated or redundant entry in the table may be identified and deleted. Alternatively, the outdated or redundant entry may be disregarded rather that deleted.

The data associated with the write command may be transferred from the temporary storage block to the logical block address in response to a trigger event. The trigger event may be defined in a variety of way according to various embodiments. For example, the trigger event may comprise the table being filled to a predetermined level. In another example, the trigger event may comprise the temporary storage block being filled to a predetermined level. In yet another example, the trigger event may comprise a passage of a predetermined amount of time.

Further embodiments of the present invention include systems for managing data in non-volatile memory that may comprise a non-volatile memory controller in communication with the non-volatile memory. The non-volatile memory controller may comprise a communications module and a data management module. The communications module may be configured to receive a write command indicating a logical block address for writing data associated with the write command. The data management module may be configured to write the data associated with the write command to the temporary storage block of the logical zone when a size of the data associated with the write command does not exceed a threshold. The data management module may be further configured to transfer the data associated with the write command from the temporary storage block to the logical block address in response to a trigger event. The non-volatile memory controller may further comprise a record management module configured to update a table associated with the temporary storage block to reflect the writing of the data associated with the write command to the temporary storage block.

Embodiments of the present invention may further include computer-readable storage media having embodied thereon programs that, when executed by a computer processor device, perform methods associated with managing data in non-volatile memory.

### BRIEF DESCRIPTION OF THE DRAWINGS

FIG. 1 is an exemplary block diagram of a system employing embodiments of the present invention.

FIG. 2 is a block diagram of non-volatile memory according to exemplary embodiments.

FIG. 3 is a block diagram of an exemplary non-volatile memory controller.

FIG. 4 is a flowchart of an exemplary method for managing data in a non-volatile memory system.

### DETAILED DESCRIPTION OF EXEMPLARY EMBODIMENTS

Embodiments of the present invention provide systems and methods for managing data in a non-volatile memory system that includes a non-volatile memory controller in communication with non-volatile memory such as NAND flash. Numerous temporary storage blocks are distributed across the non-volatile memory. Each temporary storage block resides in one of several logical zones. The logical zones each include a different range of logical block addresses.

As write commands are received by the non-volatile memory controller, a determination is made as to whether data associated with the write command exceeds a size threshold. If the data does exceed the threshold, the data is written directly to the logical block address specified by the write command. On the other hand, if the data does not exceed the threshold, the data is written to the temporary storage block within the logical zone that also includes the logical block address specified by the write command.

In response to a trigger event, such as the temporary storage block being filled to a predetermined level or a passage of a predetermined amount of time, the data is transferred from the temporary storage block to the logical block address indicated by the write command. By identifying and deleting outdated or redundant data in the temporary storage blocks, the total number of erase cycles in the non-volatile memory may be significantly reduced. Additionally, the non-volatile memory system may use less RAM, have lower power consumption, and have increased longevity in comparison with conventional systems.

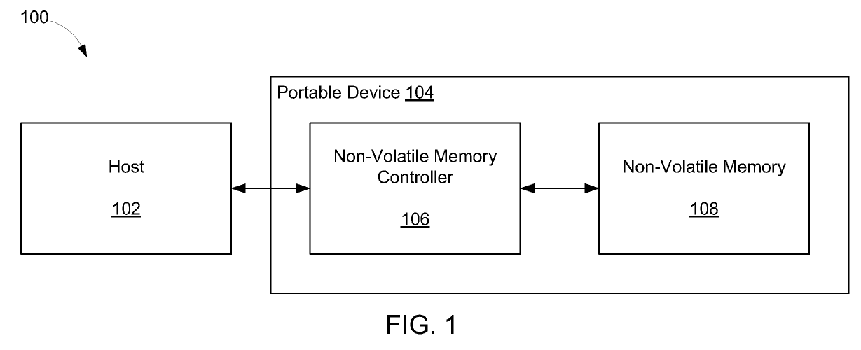

Referring now to FIG. 1, an exemplary block diagram of a system 100 employing embodiments of the present invention is shown. As depicted, the system 100 includes a host 102 in communication with a portable device 104, which in turn includes a non-volatile memory controller 106 and non-volatile memory 108. In alternative embodiments, the host 102 and the portable device 104 may be combine into a single device.

The host 102 may be any device that can interface with a portable storage device such as portable device 104. Examples of the host 102 may include personal computers, personal digital assistants (PDAs), and various other computing devices. Examples of the host 102 may also include printers, digital cameras, scanners, and other devices that may store and retrieve data from the portable device 104. Many of these examples may have a software-based or firmware-based operating system that sends write commands to the portable device 104.

The portable device 104 may be any device that includes non-volatile memory in that stored information is retained whether or not the portable device 104 is powered. For illustrative purposes, non-volatile memory is discussed herein in the context of flash memory. Flash memory is used in a number of applications such as USB flash drives and various memory cards. Flash memory may also be used in personal digital assistants (PDAs), laptop computers, digital audio players, digital cameras, and mobile phones. The portable device 104 may be communicatively coupled with the host 102 either physically or wirelessly in accordance with various embodiments. For example, the portable device 104 may include a USB plug that may be connected to a USB port of the host 102.

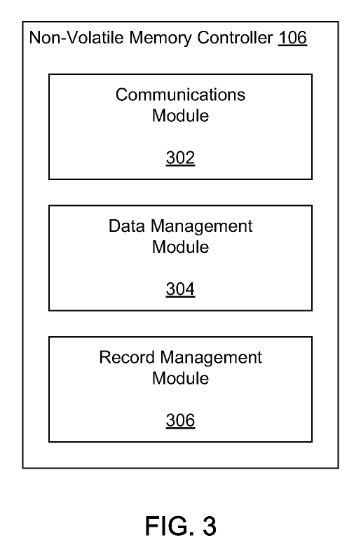

The non-volatile memory controller 106 may be a small microcontroller with some amount of on-chip ROM and/or RAM. The non-volatile memory controller 106 may include software and/or firmware that may execute various modules described herein. As such, the non-volatile memory controller 106 may function as an intermediary between the host 102 and the non-volatile memory 108. For example, the non-volatile memory controller 106, or various module thereof, may receive write commands from the host 102 and determine how data associated with those write commands is managed with respect to the non-volatile memory 108. According to various embodiments, the non-volatile memory controller 106 may include one of several common architectures. Exemplary embodiments of the non-volatile memory controller 106 are discussed further in connection with FIG. 3.

The non-volatile memory 108 may include any type of memory that can be electrically erased and rewritten such as NAND flash and NOR flash. The non-volatile memory 108 may comprise other memory technologies as they become available.

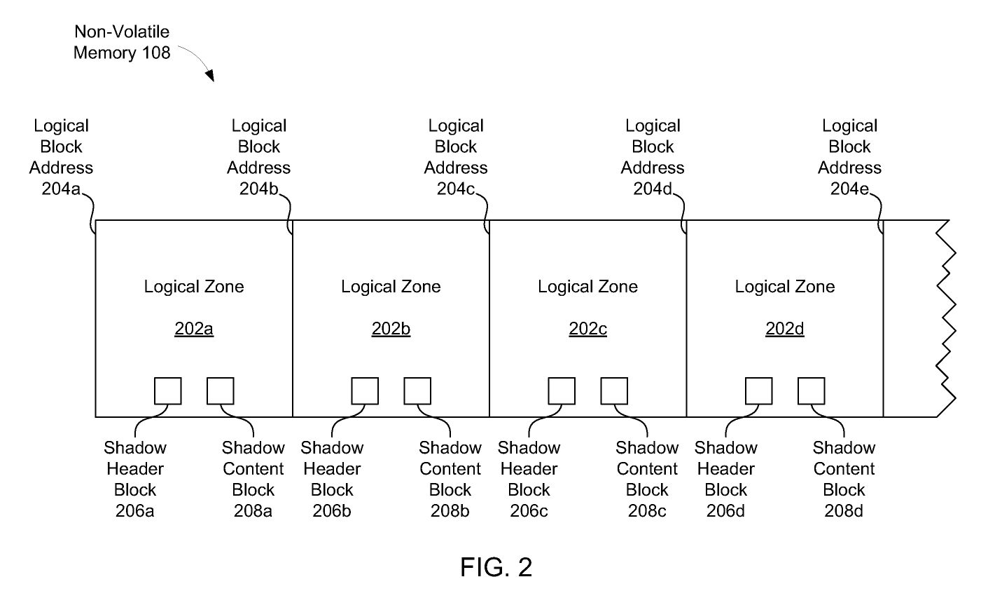

FIG. 2 is a block diagram of the non-volatile memory 108 according to exemplary embodiments. The non-volatile memory 108 is depicted as including numerous logical zones 202 that are each defined by a range of logical block addresses 204. For example, logical zone 202b is defined as the range between the logical block address 204b and the logical block address 204c, whereas logical zone 202c is defined as the range between the logical block address 204c and the logical block address 204d. Each logical zone 202 includes one or more shadow blocks. As illustrated in FIG. 2, each logical zone 202 includes a shadow header block 206 and a shadow content block 208.

The shadow header blocks 206 may be configured to store header information associated with write commands received by the non-volatile memory controller 106. Generally speaking, header information may describe supplemental data placed at the beginning of a block of data being stored or transmitted. The header information may precede content or a ‘payload’ associated with the write command. The header information may indicate a logical block address to which the content should be written. Additionally, the header information may include one or more of a sector count, a sector or page offset, a date and time of receipt of the write command, a sender's and a recipient's IP addresses, a protocol governing a format of the content, or a fingerprint or signature to identify a specific file format and corresponding software utility.

The shadow content blocks 208 may be configured to store the content or payload associated with the write command received by the non-volatile memory controller 106. This content may include, for example, file system data. User data may also be included in the content. The shadow header blocks 206 may be used when transferring the content stored by the shadow content blocks 208 to the logical block address originally indicated by the write command.

According to some embodiments, the shadow header blocks 206 and the shadow content blocks 208 may be physically stored in RAM included in the non-volatile memory controller 106. In exemplary embodiments, firmware may allocate 512 bytes, 1024 bytes, or 2048 bytes of RAM for the shadow header blocks 206 and the shadow content blocks 208. In addition, the contents of the shadow header blocks 206 and/or the shadow content blocks 208 may be analyzed, either continually, periodically, or based on some trigger event, in order to identify, and delete or disregard, redundant or outdated entries, as described further herein. Deleting redundant or outdated entries may delay transference of data in the shadow content blocks 208 to the logical block address indicated by a corresponding write command.

FIG. 3 is a block diagram of the exemplary non-volatile memory controller 106. As depicted, the non-volatile memory controller 106 includes a communication module 302, a data management module 304, and a record management module 306. The non-volatile memory controller 106 may execute its constituent modules to effectuate the functionality corresponding thereto. Although FIG. 3 describes the non-volatile memory controller 106 as including various modules, fewer or more modules may be comprised by the non-volatile memory controller 106 and still fall within the scope of various embodiments. For example, the functionality of the data management module 304 and the functionality of the record management module 306 may be combined into a single module in accordance with some embodiments.

The communications module 302 may be configured to communicate with the host 102. For example, the communications module 302 may receive a write command indicating a logical block address for writing data associated with the write command. The write command may include header information and content as discussed herein. In another example, the communications module 302 may send data to the host 102 such as in response to a request. Furthermore, the communications module 302 may be configured to send and receive data between the non-volatile memory controller 106 and the non-volatile memory 108. Consequently, the communications module 302, in conjunction with other modules included in the non-volatile memory controller 106, may act as an intermediary between the host 102 and the non-volatile memory 108.

The data management module 304 may be configured to write the data associated with the write command received by the communications module 302 to one or more temporary storage blocks of the logical zone when a size of the data associated with the write command does not exceed a threshold. For example, the communications module 304 may receive at write command indicating that a certain portion of data should be written to a logical block address within logical zone 202d, referring back to FIG. 2. If that portion of data has a size less that the threshold, header information associated with that portion of data may be temporarily stored in the shadow header block 206d, while the content associated with that portion of data may be temporarily stored in the shadow content block 208d.

It is noteworthy that the threshold may be static or dynamic. For example, the threshold set at a fixed value so that data associated with a write command that is less than that fixed value will be temporarily stored in one or more temporary storage blocks, such as the shadow header blocks 206 and the shadow content blocks 208 illustrated in FIG. 2. Alternatively, the threshold may be dynamic such that it changes as system performance requirements change.

The data management module 304 may be further configured to transfer the data associated with write commands from temporary storage blocks to logical block addresses in response to a trigger event. Referring to the example above, the header information associated with the portion of data temporarily stored in the shadow header block 206d may be used to transfer the corresponding content temporarily stored in the shadow content block 208d to the logical block address originally indicated by the write command in response to some trigger event. According to various embodiments, that trigger event may be a table describing data in the shadow header blocks 206 and/or the shadow content blocks 208 being filled to a predetermined level. Such a table is discussed further in connection with the record management module 306. In other embodiments, the trigger event may be one or more of the temporary storage blocks (e.g., the shadow header blocks 206 or the shadow content blocks 208) themselves being filled to a predetermined level. Additionally, the trigger event may be a passage of a predetermined amount of time in further embodiments.

The record management module 306 may be configured to update a table associated with the temporary storage block to reflect the writing of the data associated with the write command to temporary storage blocks such as the shadow header blocks 206 and/or the shadow content blocks 208. Entries in such a table for a received write command may include the logical block address indicated by the write command, the sector count of the content associated with the write command, and a shadow content block page offset. The shadow content block page offset may indicate the position of corresponding content within a given shadow content block 208. The record management module 306 may be further configured to identify an outdated or redundant entry in the table. Accordingly, the record management module 306 may disregard or delete the outdated or redundant entry from the table, and may correspondingly delete the data in the shadow header blocks 206 and/or the shadow content blocks 208 specified by that outdated or redundant entry.

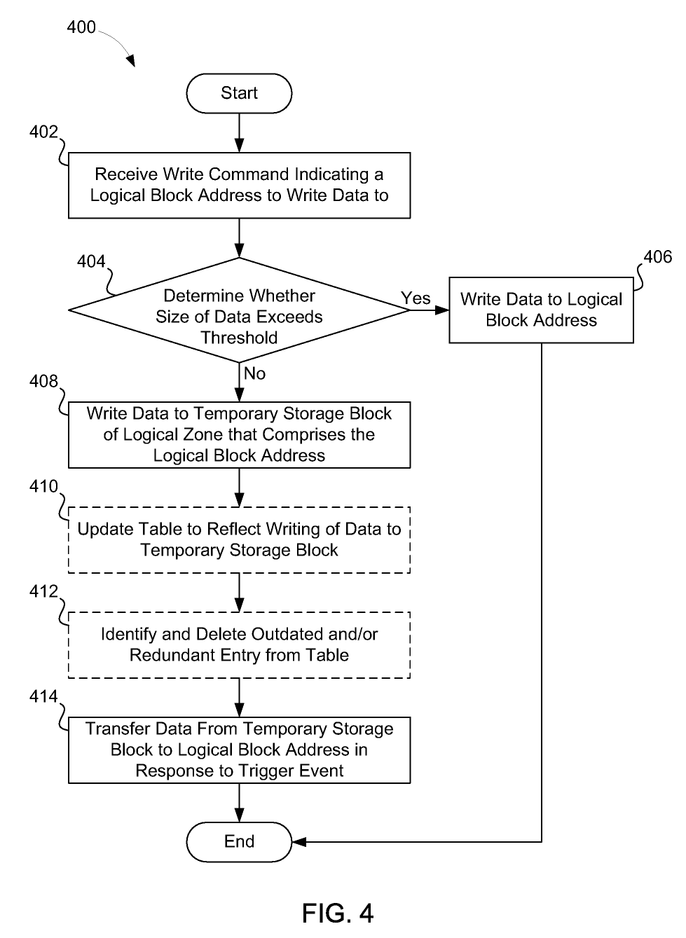

FIG. 4 is a flowchart of an exemplary method 400 for managing data in a non-volatile memory system. It is noteworthy that steps of the method 400 may be performed in varying orders. Additionally, various steps may be added or subtracted from the method 400 and still fall within the scope of the present invention.

In step 402, a write command is received that indicates a logical block address for writing data associated with the write command. As discussed herein, the logical block address may be within a logical zone defined by a range of logical block addresses. Additionally, the logical zone may comprise a temporary storage block. For example, referring back to FIG. 2, the write command may indicate the logical zone 202a, which includes the shadow content block 208a. In exemplary embodiments, the communications module 302 may receive the write command from the host 102.

In step 404, a determination is made as to whether the size of the data associated with the write command exceeds a threshold. In exemplary embodiments, the threshold may be data sizes exceeding one sector. The communications module 302 may perform step 404 in accordance with exemplary embodiments. In alternative embodiments, the data management module 304 may perform step 404. If the data does exceed the threshold, the method 400 proceeds to step 406. Conversely, if the data does not exceed the threshold, the method 400 proceeds to step 408.

In step 406, the data associated with the write command is written to the logical block address originally indicated by the write command when the data associated with the write command received in step 502 does exceed the threshold. In exemplary embodiments, the data management module 304 may perform step 406.

In step 408, the data associated with the write command is written to a temporary storage block of the logical zone that includes the logical block address originally indicated by the write command. According to various embodiments, header information associated with write commands may be stored by or written to one of the shadow header blocks 206, while the content or payload associated with the write command may be stored by or written to the shadow content blocks 208. In exemplary embodiments, the data management module 304 may perform step 408.

In step 410, a table associated with the temporary storage block is updated to reflect the writing of the data associated with the write command in step 408. According to various embodiments, step 410 may be optional. Entries in such a table for the write command received in step 402 may include the logical block address indicated by the write command, the sector count of the content associated with the write command, and a shadow content block page offset. In exemplary embodiments, the record management module 304 may perform step 410.

In step 412, one or more outdated and/or redundant entries in the table mentioned in step 410 are identified and deleted. In alternative embodiments, the one or more outdated and/or redundant entries may be disregarded rather than deleted. Step 412 may be optional in accordance with various embodiments. The record management module 304 may perform step 412 in exemplary embodiments.

In step 414, the data associated with the write command is transferred from the temporary storage block to the logical block address originally indicated by the write command in step 402. This transfer is executed in response to a trigger event. The trigger event may be defined in a variety of way according to various embodiments. For example, the trigger event may comprise the table being filled to a predetermined level. In another example, the trigger event may comprise the temporary storage block being filled to a predetermined level. In yet another example, the trigger event may comprise a passage of a predetermined amount of time. The data management module 304 may perform step 414 in accordance with exemplary embodiments.

It is noteworthy that any hardware platform suitable for performing the processing described herein is suitable for use with the invention. Computer-readable storage media refer to any medium or media that participate in providing instructions to a processor for execution. Such media can take forms, including, but not limited to, non-volatile and volatile media such as optical or magnetic disks and dynamic memory, respectively. Common forms of computer-readable storage media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a processor or microcontroller for execution. A bus may carry the data to system RAM, from which a processor or microcontroller may retrieve and execute the instructions. The instructions received by system RAM can optionally be stored on a fixed disk either before or after execution by a processor.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for managing data in a non-volatile memory system, the method comprising:
receiving a write command indicating a logical block address for writing data associated with the write command, the logical block address within a logical zone, the logical zone further comprising a temporary storage block;
writing the data associated with the write command to the temporary storage block of the logical zone when a size of the data associated with the write command does not exceed a threshold; and
transferring the data associated with the write command from the temporary storage block to the logical block address in response to a trigger event.

2. The method of claim 1, further comprising updating a table associated with the temporary storage block to reflect the writing of the data associated with the write command to the temporary storage block.

3. The method of claim 2, further comprising identifying an outdated or redundant entry in the table.

4. The method of claim 3, further comprising deleting the outdated or redundant entry from the table.

5. The method of claim 2, wherein the trigger event comprises the table being filled to a predetermined level.

6. The method of claim 1, wherein the trigger event comprises the temporary storage block being filled to a predetermined level.

7. The method of claim 1, wherein the trigger event comprises a passage of a predetermined amount of time.

8. The method of claim 1, wherein the threshold is a fixed value.

9. The method of claim 1, wherein the data associated with the write command comprises file system data.

10. The method of claim 1, wherein the data associated with the write command comprises user data.

11. The method of claim 1, wherein the logical zone is one of a plurality of logical zones within non-volatile memory, each of the plurality of logical zones comprising a different range of logical block addresses than the rest of the plurality of logical zones.

12. A system for managing data in non-volatile memory, the system comprising:
a non-volatile memory controller in communication with the non-volatile memory, the non-volatile memory controller comprising:
a communications module configured to receive a write command indicating a logical block address for writing data associated with the write command, the logical block address within a logical zone, the logical zone further comprising a temporary storage block; and
a data management module configured to write the data associated with the write command to the temporary storage block of the logical zone when a size of the data associated with the write command does not exceed a threshold, and to transfer the data associated with the write command from the temporary storage block to the logical block address in response to a trigger event.

13. The system of claim 12, wherein the non-volatile memory controller further comprises a record management module configured to update a table associated with the temporary storage block to reflect the writing of the data associated with the write command to the temporary storage block.

14. The system of claim 13, wherein the record management module is further configured to identify an outdated or redundant entry in the table.

15. The system of claim 14, wherein the record management module is further configured to delete the outdated or redundant entry from the table.

16. The system of claim 13, wherein the trigger event comprises the table being filled to a predetermined level.

17. The system of claim 12, wherein the trigger event comprises the temporary storage block being filled to a predetermined level.

18. The system of claim 12, wherein the trigger event comprises a passage of a predetermined amount of time.

19. The system of claim 12, wherein the logical zone is one of a plurality of logical zones within the non-volatile memory, each of the plurality of logical zones comprising a different range of logical block addresses than the rest of the plurality of logical zones.

20. A computer readable storage medium having a program embodied thereon, the program executable by a processor to perform a method for managing data in a non-volatile memory system, the method comprising:
receiving a write command indicating a logical block address for writing data associated with the write command, the logical block address within a logical zone, the logical zone further comprising a temporary storage block;
writing the data associated with the write command to the temporary storage block of the logical zone when a size of the data associated with the write command does not exceed a threshold; and
transferring the data associated with the write command from the temporary storage block to the logical block address in response to a trigger event.
